(19) United States
(12) Patent Application Publication
(10) Pub. No.: US 2004/0154211 A1
(43) Pub. Date: Aug. 12, 2004

(54) Light-reflecting bird-repelling device and method

(76) Inventor: Oscar R. Campas, Vail, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/754,179

(22) Filed: Jan. 9, 2004

Related U.S. Application Data
(63) Continuation-in-part of application No. 09/996,185, filed on Nov. 28, 2001, now abandoned.

(51) Int. Cl. A01M 1/00

(52) U.S. Cl. 43/1

(57) ABSTRACT

Bird-repelling devices and methods involving the reflection of light so as to disorient and thereby discourage birds from perching on outside structures. The devices feature an upside down “v” or a “w”-shaped reflector that is mounted to the top of a structure, such as a billboard. These reflectors provide a repelling effect while minimizing the reflection of light to the ground, thereby lessening any chance of distraction to motorists or pedestrians caused by glare. The invention also includes a structure for pivotally attaching the reflectors, such as by a cog and gear, that allow the reflectors to track the sun or other source of light.

### STATEMENT OF RELATED APPLICATIONS

This application is a continuation-in-part of, and claims priority to, U.S. patent application Ser. No. 09/996,185, which was filed on Nov. 28, 2001 by the same inventor.

### BACKGROUND OF THE INVENTION

1. Field of the Invention

This invention relates generally to devices and methods for repelling animals such as birds. In particular it relates to devices that reflect light such that birds are discouraged from landing or nesting upon objects associated with such devices, as well as methods of repelling animals while minimizing glare.

2. Description of the Related Art

There has always been a need for controlling the congregation of birds around external structures, e.g. buildings, due to the unsightly and unsanitary conditions caused by bird droppings. Thus, a number of inventions have been developed to protect structures from such degradation.

Of particular concern to the advertising industry is the damage caused by birds to the numerous billboards, kiosks, and other commercial information-imparting structures. The expense from having to clean up or replace these types of structures is compounded by their typically elevated or otherwise inaccessible locations.

Conventional approaches to the bird-damage problem have involved the use of chemical substances, arrays of spikes, or barriers to prevent landing and/or roosting. Obviously, an ideal repellent should not be harmful to birds or the environment. In this regard, U.S. Pat. No. 5,913,780 discloses a barrier for repelling birds that includes a triangular hollow section having mutually perpendicular sides and an upper surface that is inclined sufficiently to prevent birds from roosting thereupon.

However, unlike building ledges, structures with unobstructed top surfaces, such as billboards, may not be suitable for these types of barriers because persistent birds, most notably pigeons, may simply cling to the top of the triangle since there is no adjacent wall that prevents them for doing so.

Another approach to the related problem of protecting domestic animals from birds-of-prey has involved the use of reflected light. For example, U.S. Pat. No. 1,287,968 issued to Greenleaf discloses a light reflector that features a pyramidal structure and bells for blinding and frightening away chicken hawks and similar birds. While Geenleaf's reflector may be effective for its intended purpose, its design is unnecessarily complicated. Moreover, the pyramidal shape of the reflector causes light to be reflected in such a way that glare may be produced, resulting in potential distraction for motorists or pedestrians.

U.S. Pat. No. 2,306,080 by Peles discloses bird-proofing devices made from strips of sheet metal. While the metal may reflect light, the principal function of Pele's invention is to project sharp points and edges at various angles to prevent small birds from landing thereon. Thus, light is reflected in practically all directions.

Similarly, U.S. Pat. No. 4,269,008 by Assouline discloses closely spaced pyramid-like structures used to repel birds from nesting on structures. While Assouline's invention is specifically designed to reflect light, it also does so in most every direction.

Thus, there remains a need in the art for an effective light reflection-based, bird-repelling device and method that is simple in design and use, inexpensive to produce, and minimally distracting to humans.

### BRIEF SUMMARY OF THE INVENTION

The invention relates in general to devices and methods that involve reflecting light so as to disorient and thereby discourage birds from perching on outside structures. More particularly, the invention involves an upside down “v” or a “w”-shaped reflector that preferably is mounted to the top of a structure, such as a billboard. These reflectors provide a repelling effect to birds while minimizing the reflection of light to the ground, thereby lessening the chance of distraction caused by glare to motorists or pedestrians. The invention may also include means for pivotally attaching the reflectors such that they can be positioned to track the sun or other source of light.

Thus, the bird-repelling device according to the present invention substantially departs from the conventional concepts and designs of the prior art by providing light-reflecting apparatuses that are inexpensively produced and easily placed on billboards and other elevated structures, such as canopies, building ledges, and the like. Moreover, the invention is harmless and does not require power to operate.

A principal objective of this invention is to provide a reliable but simple bird-repelling device.

Another objective of the invention is to provide a bird-repelling device that is easy and inexpensive to install upon billboards and other difficult to access structures.

Another goal is to provide a new and improved bird-repelling device that is non-toxic and more aesthetically pleasing then spikes and other conventional forms of bird repelling.

Yet another objective is to provide a light-reflecting bird-repelling device and method for billboards and other outdoor structures that produces a minimal amount of glare to passing motorists or pedestrians through the inclusion of light-trapping cavities.

In contrast to the related art, the structural arrangement of the present invention effectively reflects light to repulse birds while minimizing the light that is reflected down into the eyes of viewers on the ground. This is so because the “-v” configuration of the “v-shaped member” and placement of the supporting member on the interior surface of the v-shaped member (i.e. not on the outer edges) create a kind of “light capturing cavity” on the underside of the v-shaped member. None reference of the related art is know to disclose the prevention of this sort of undesirable glare.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiment and particularly pointed out in the claims. However, such drawings and description disclose but one of the various ways in which the invention may be practiced. All publications cited are hereby incorporated by reference in their entirety herein.

### BRIEF DESCRIPTION OF THE DRAWINGS

FIG. 1A schematically depicts a side elevation view of a preferred embodiment of the invention attached to a billboard.

FIG. 1B schematically depicts a front perspective view of the reflector of FIG. 1 A without a baseplate.

FIG. 2 schematically depicts in side elevation view a variation of the embodiment shown in FIG. 1.

FIG. 3 schematically depicts a side elevation view of the embodiment of FIG. 2 using an alternative means for attachment.

FIG. 4 schematically depicts a second preferred embodiment showing an optional gearing system for tracking a source of light.

FIG. 5 schematically depicts the light-trapping cavities of the invention using the device shown in FIG. 1A.

### DESCRIPTION OF THE PREFERRED EMBODIMENT OF THE INVENTION

The present invention generally features structurally unique reflectors that operate to repel birds from perching on billboards and other elevated structures. Preferably, an upside down “v” or a “w”-shaped reflector is mounted to the top surface of the structure and to discourage birds from landing on or nearby through a disorienting effect caused by the reflection of light.

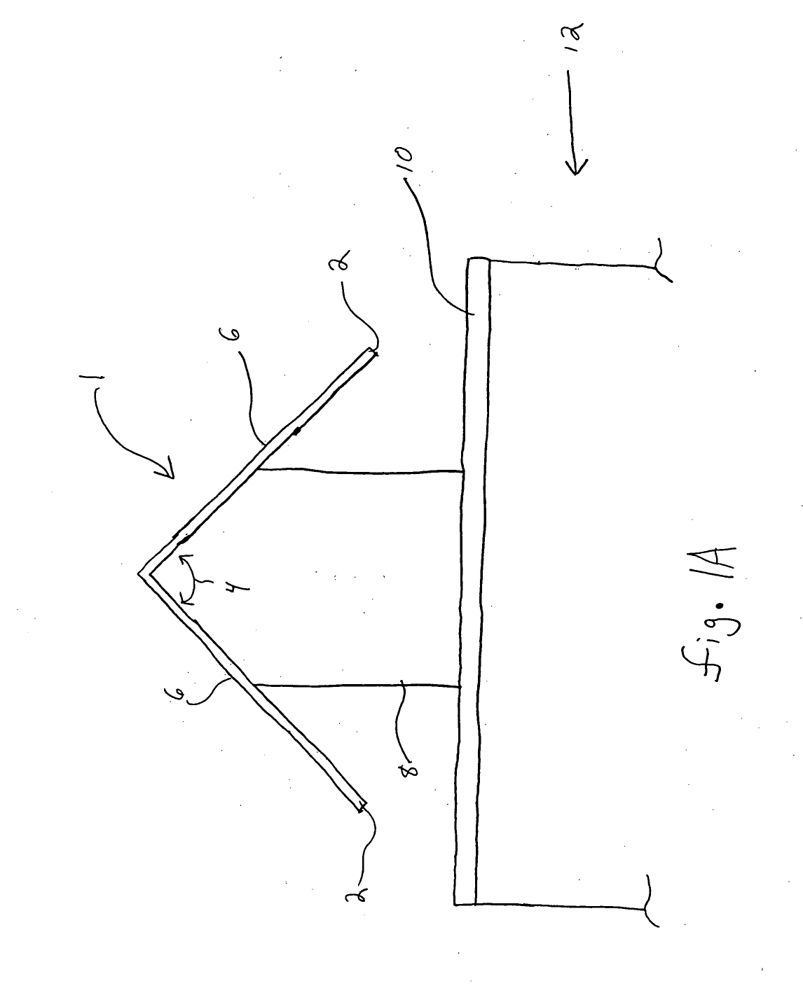

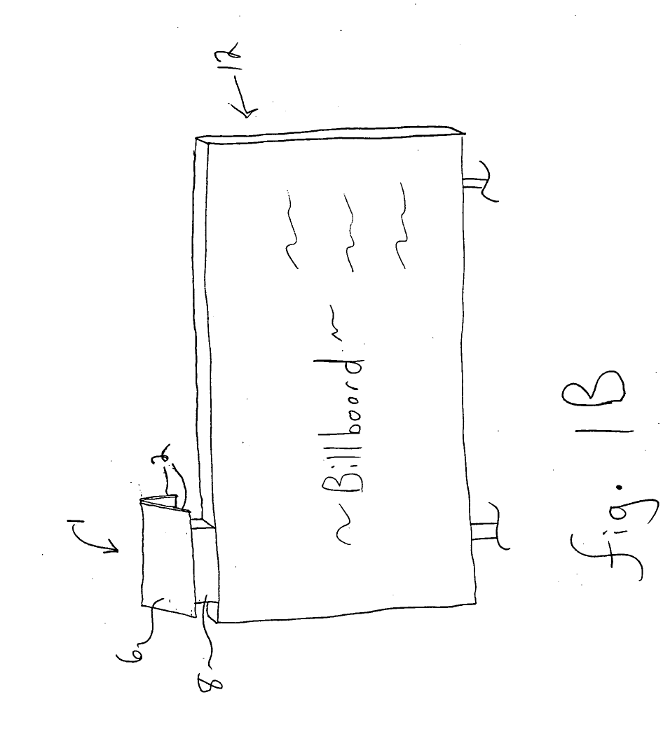

Referring to the drawings, wherein like parts are designated throughout with like numerals, FIG. 1A illustrates in side elevation view a preferred reflector apparatus 1 according to the invention. The reflector 1 includes two substantially rectangular planar members 2 that slope downwardly to form an angle 4 therebetween. Preferably, the angle 4 is approximately 90 degrees or greater so that the occurrence of glare is minimized or eliminated for persons at a frame of reference that is lower in height when compared to the apparatus 1.

The planar members 2 each have an exterior reflective surface 6 for reflecting light to scare the birds away from the protected structure. Preferably, the reflective surface is a mirror. However, any bright, metallic, or mirror-like surface may be used in accordance with the invention.

Preferably, the reflector 1 is then held in place by a support 8. In this particular embodiment, the support 8 also includes a baseplate 10. The baseplate 10 assists in the mounting of the invention to the top of a billboard 12 (or other structure) by providing a large surface area for the application of bonding agents or adhesives. Alternatively, the invention may be mounted directly by the support 8 (i.e. without a baseplate 10) through any conventional means, including, but not limited to, nails, screws, magnets, or a sleeve made to slip over a billboard of a particular configuration. Thus, FIG. 1B schematically depicts a frontal view of the reflector of FIG. 1A, except that the support 8, rather then a baseplate, serves to directly attach the reflector to the billboard 12.

Of course, the planar members 2 may be of unitary construction rather than two or more pieces that have been joined together. Moreover, the invention may assume shapes other than rectangles, for example, the planer members 2 may be circular or triangular in appearance.

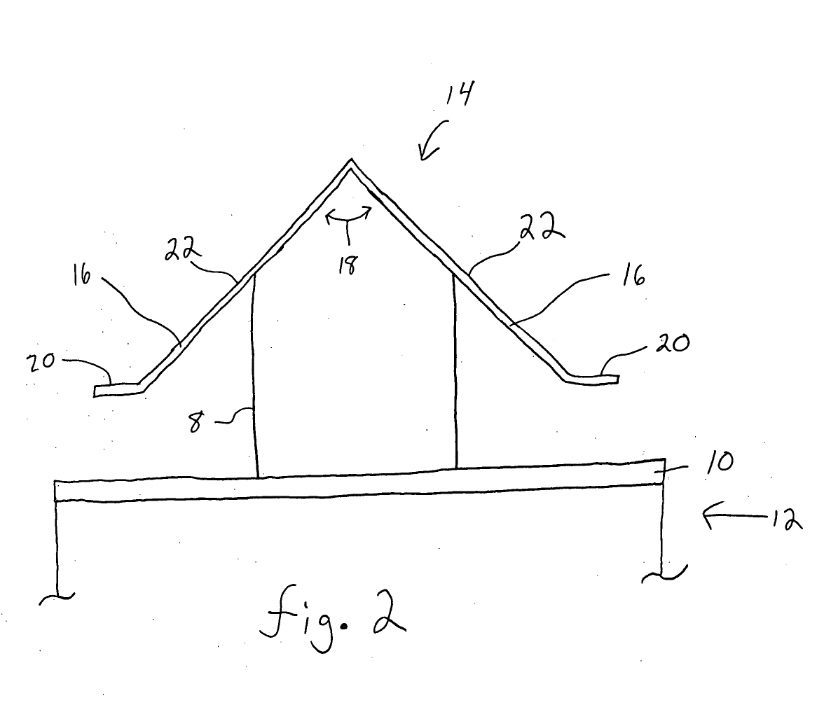

Turning to FIG. 2, a modified reflector 14 based on the embodiment of FIG. 1 is shown. Reflector 14 has two substantially rectangular planar members 16 that slope downwardly to form an angle 18, which is preferably greater than 90 degrees. Each planar member 16 terminates with a substantially flat end 20. The flat ends 20 are roughly parallel to the baseplate 10 and are thought to further reduce any glare experienced by observers on the ground by further directing some reflected light upward. The reflector 14 may fabricated as a single unit that covers the top of a billboard or other structure, or it may be manufactured as individual subunits that are placed at predetermined intervals, such as every six inches.

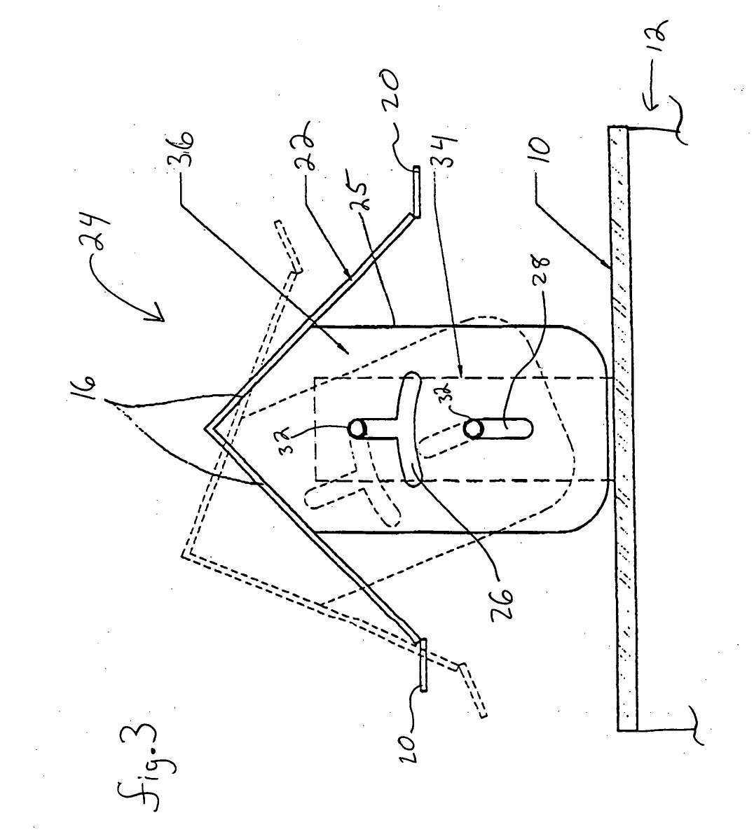

In FIG. 3, an alternative means for mounting the embodiment of FIG. 2 is depicted. Reflector 24 is connected to support bracket 25, which contains an upper slotted aperture 26 and a lower aperture 28. Both slotted aperture 26 and aperture 28 are adapted to receive pins 32, which are located on a second support member 34 that is mounted to billboard 12 by baseplate 10.

The configuration of the slotted aperture is such that the reflector 24 may be pivoted to one of three alternate positions (one of which is generally designated 36 and shown in phantom line). Thus, the position of reflector 24 may be adjusted to better reflect light and/or reduce glare depending on the desired effect.

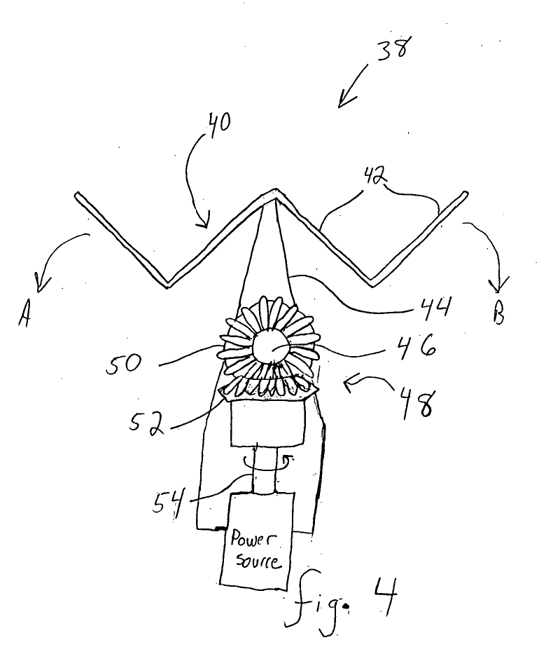

Turning to FIG. 4, a more elaborate embodiment of the invention is depicted. Reflector 38 includes a W-shaped member 40 having upward reflecting surfaces 42. The W-shaped member is attached to a support member 44, which is fixedly attached to rod 46. Although not clearly shown, support member 44 contains a hole through which rod 46 is rotatably mounted.

At the end of rod 46 there is a gear and cog wheel arrangement 48, which is made up of vertical beveled gear 50 (secured to rod 46) and horizontal beveled gear 52 (secured to drive shaft 54). In response to a power source, drive shaft 54 rotates beveled gear 52 such that beveled gear 50 is turned either clockwise or counter-clockwise. Since support member 44 is fixed to rod 46, the reflector 40 responds by pivoting in either direction A or B. Thus, the reflector 38 may be remotely or otherwise controlled to track the sun or other light source.

One clever aspect of this invention is the fact that its structural arrangement effectively reflects light to repulse birds while minimizing light from being reflected down into the eyes of viewers on the ground. This is so because the upside down “v” configuration of the “v-shaped member” and placement of the supporting member on the interior surface of the v-shaped member (i.e. not on the outer edges) create a kind of “light capturing cavity” on the underside of the v-shaped member.

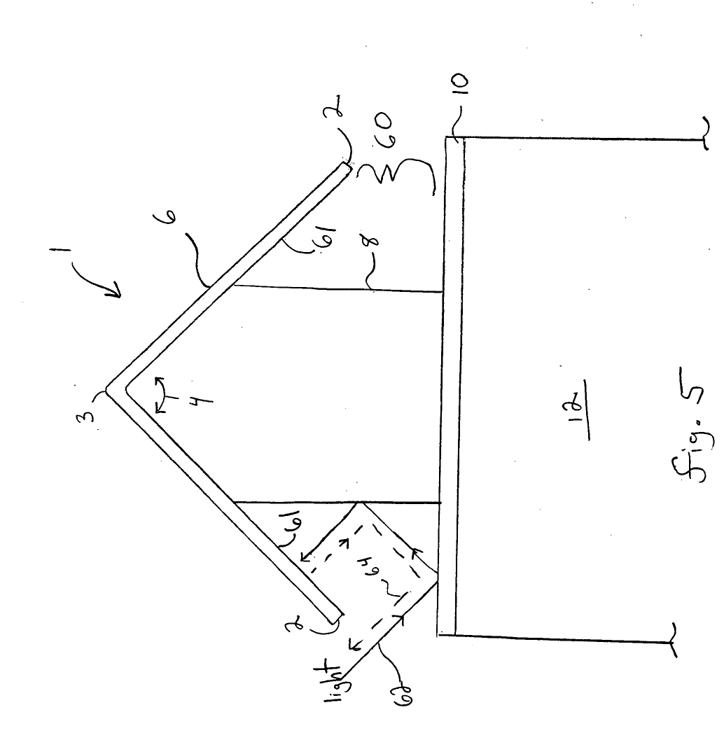

For example, turning to FIG. 5, the apparatus 1 has two quadrilateral planar members 2 joined together along a single horizontal edge 3 so as to form an upside down v-shaped member having an angle 4 between respective planar surfaces of the quadrilateral planar members 2, with the two quadrilateral planar members 2 having exterior light-reflective surfaces 6 and a support member 8 including a baseplate 10. Consequently, the structure 12 is connected to the interior surface 61 of the upside down v-shaped member in spaced-apart relation, thereby forming a light-trapping cavity 60 between the interior surface 61 of the upside down v-shaped member and the support member 8. If the interior surface 61, support member 8, and baseplate 10 are made from or coated with materials that do not reflect light well, then light (such as light ray 62) become “trapped” or dissipate inside cavity 60.

Alternatively, interior surface 61, support member 8, and baseplate 10 can be made light reflective. In this case, even more light is reflected skyward while glare is still minimized due to the geometry of the “light trapping cavity” 60 as illustrated by light ray 64.

Using the embodiment of the invention illustrated in FIG. 5, a method for keeping birds away from a billboard 12 (or other structure) would include the steps of (a) providing an apparatus 1 having two quadrilateral planar members 2 joined together along a single horizontal edge 3 so as to form an upside down v-shaped member having an angle 4 between respective planar surfaces of the quadrilateral planar members 2, with the two quadrilateral planar members having exterior light-reflective surfaces 6 and a support member 8 that includes a baseplate 10 for connecting the structure 12 to the interior surface 61 of the upside down v-shaped member in spaced-apart relation, thereby forming a light-trapping cavity 60 between the interior surface 61 of the upside down v-shaped member and the support member 8; and (b) mounting the apparatus 1 to the structure 10.

Various changes in the details, steps and components that have been described may be made by those skilled in the art within the principles and scope of the invention herein illustrated and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

I claim:

1. An apparatus for keeping birds away from a structure comprising:
two quadrilateral planar members joined together along a single horizontal edge so as to form an upside down v-shaped member having an angle between respective planar surfaces of said quadrilateral planar members, said two quadrilateral planar members having exterior light-reflective surfaces; and
a support member connecting said structure and an interior surface of said upside down v-shaped member in spaced-apart relation, wherein a light-trapping cavity is formed between the interior surface of said upside down v-shaped member and said support member.

2. The apparatus of claim 1, wherein said exterior light-reflective surfaces are mirrors.

3. The apparatus of claim 1, wherein said support member includes a baseplate.

4. The apparatus of claim 1, wherein said support member further includes a means for tracking a source of light.

5. The apparatus of claim 4, wherein said means for tracking a source of light comprises two pins in fixed relationship to said structure and two slotted apertures in said support member, such that the apparatus is freely supported by engaging said pins in said apertures and is pivotally adjustable between alternative relative positions of the pins in the apertures.

6. The apparatus of claim 4, wherein said means for tracking a source of light comprises a gear and cog wheel arrangement.

7. The apparatus of claim 1, wherein said support member and said interior surface reflect light.

8. The apparatus of claim 3, wherein said baseplate reflects light.

9. The apparatus of claim 1, wherein said angle is about 90 degrees.

10. An apparatus for keeping birds away from a structure comprising:
two quadrilateral planar members joined together along a single horizontal edge so as to form an upside down v-shaped member having an angle between respective planar surfaces of said planar members, said two quadrilateral planar members having exterior light-reflective surfaces, wherein each of said two quadrilateral planer members further includes a substantially horizontal end extending outwardly therefrom; and
a support member connecting said structure and an interior surface of said upside down v-shaped member in spaced-apart relation, wherein a light-trapping cavity is formed between the interior surface of said upside down v-shaped member and said support member.

11. The apparatus of claim 10, wherein said exterior light-reflective surfaces are mirrors.

12. The apparatus of claim 10, wherein the support member includes a baseplate.

13. The apparatus of claim 10, wherein said support member is connected to a means for tracking a source of light.

14. The apparatus of claim 13, wherein said means for tracking a source of light comprises two pins in fixed relationship to a structure and two slotted apertures in said support member, such that the apparatus is freely supported by engaging said pins in said apertures and is pivotally adjustable between alternative relative positions of the pins in the apertures.

15. The apparatus of claim 13, wherein said means for tracking a source of light comprises a gear and cog wheel arrangement.

16. The apparatus of claim 10, wherein said support member and said interior surface reflect light.

17. The apparatus of claim 12, wherein said baseplate reflects light.

18. A method for keeping birds away from a structure, comprising the steps of:
(a) providing an apparatus comprising two quadrilateral planar members joined together along a single horizontal edge so as to form an upside down v-shaped member having an angle between respective planar surfaces of said quadrilateral planar members, said two quadrilateral planar members having exterior light-reflective surfaces and a support member connecting said structure and an interior surface of said upside down v-shaped member in spaced-apart relation, wherein a light-trapping cavity is formed between the interior surface of said upside down v-shaped member and said support member; and
(b) mounting said apparatus on said structure.
